(19) United States
(12) Patent Application Publication
(10) Pub. No.: US 2025/0261115 A1
(43) Pub. Date: Aug. 14, 2025

(54) LOW-POWER REFERENCE SIGNAL FOR CELL RE-SELECTION

(71) Applicant: Sony Group Corporation, Tokyo (JP)

(72) Inventors: Nafiseh Seyed MAZLOUM, Lund (SE); Anders BERGGREN, Lund (SE); Basuki PRIYANTO, Lund (SE); Torgny PALENIUS, Barsebäck (SE)

(21) Appl. No.: 18/857,164

(22) PCT Filed: Apr. 25, 2023
(86) PCT No.: PCT/EP2023/060839

§ 371 Date: Oct. 15, 2024

(30) Foreign Application Priority Data
Apr. 29, 2022 (SE) 2250520-0

(51) Int. Cl. H04W 52/02; H04W 24/08; H04W 36/16

(52) U.S. Cl. CPC H04W 52/0235; H04W 24/08; H04W 36/165

(57) ABSTRACT

Various examples of the disclosure pertain to using cell-specific low-power reference signals—that may be received using a low-power receiver—for cell re-selection.

### TECHNICAL FIELD

Various examples of the disclose pertain to a reference signal designed for reception by a low-power receiver of a wireless communication device. Various examples of the disclosure pertain to performing a cell re-selection based on channel measurements that are based on such low-power reference signal.

### BACKGROUND

Energy-efficient operation is a key design requirement for wireless communication devices (user equipment; UE). A low power consumption facilitates prolonged battery life. Furthermore, smaller batteries, e.g., coin-cell batteries can be used. Internet of Things smart devices can be enabled.

One technique to facilitate low power consumption is to employ multiple receivers, a main receiver and a low-power receiver. For instance, the low-power receiver may be configured for non-coherent decoding. For non-coherent decoding, knowledge of a reference phase is not required for signal detection. This can significantly reduce the energy consumption required for channel listening. For instance, low-power receivers are employed for UEs communicating wake-up signals (WUSs) in accordance with the Third Generation Partnership Project (3GPP) protocol, see 3GPP Technical Specification (TS) 36.300, Version 16.2.0, e.g., section 10.1.4.

### SUMMARY

A need exists for energy-efficient operation of UEs.

This need is met by the features of the independent claims. The features of the dependent claims define embodiments.

Techniques for operating a UE at low power consumption are disclosed. The techniques employ a low-power reference signal (LP-RS), to support channel measurements and assessment of serving cell signal strength for UEs using a low-power receiver (LP-Rx). Alternatively or additionally, neighbor cell signal strength can be assessed.

Various examples are related to performing a cell re-selection based on channel measurements that are based on LP-RS. It may not be required that a main receiver (M-Rx) is operated in an active state, e.g., to receive signals, to perform the cell reselection. The cell re-selection can be concluded based on channel measurements that are only executed using the LP-Rx, without requiring operation of the M-Rx.

A method of operating a wireless communication device in a cellular network is disclosed. The cellular network includes a plurality of cells, each cell of the plurality of cells broadcasting a cell-specific high-power reference signal The method includes obtaining, from the cellular network, an indication of multiple cells of the plurality of cells. The base stations of the multiple cells respectively broadcast a cell-specific low-power reference signal. The method also includes monitoring, while operating in an idle mode, for the cell-specific low-power reference signal. The method also includes, upon succeeding to receive the cell-specific low-power reference signal from at least one base station of at least one of the multiple cells, performing a cell re-selection from amongst the multiple cells based on the cell-specific low-power reference signal. The method further includes, upon failing to receive the cell-specific low-power reference signal, monitoring for the cell-specific high-power reference signal for performing the cell re-selection.

For example, channel measurements may be performed based received cell-specific low-power reference signals. A received signal strength and/or received signal quality may be determined. One or more cell re-selection criteria can be considered based on the channel measurements. Depending on the outcome of the cell re-selection evaluation, the cell re-selection may or may not be performed. It would be possible that, depending on the outcome of the cell re-selection evaluation, a fallback to monitoring for the cell-specific high-power reference signal is performed.

A computer program or a computer program product or a computer-readable storage medium includes program code that can be executed by at least one processor. The at least one processor, upon executing the program code, performs a method of operating a wireless communication device in a cellular network is disclosed. The cellular network includes a plurality of cells, each cell of the plurality of cells broadcasting a cell-specific high-power reference signal The method includes obtaining, from the cellular network, an indication of multiple cells of the plurality of cells. The base stations of the multiple cells respectively broadcast a cell-specific low-power reference signal. The method also includes monitoring, while operating in an idle mode, for the cell-specific low-power reference signal. The method also includes, upon succeeding to receive the cell-specific low-power reference signal from at least one base station of at least one of the multiple cells, performing a cell re-selection from amongst the multiple cells based on the cell-specific low-power reference signal. The method further includes, upon failing to receive the cell-specific low-power reference signal, monitoring for the cell-specific high-power reference signal for performing the cell reselection.

A wireless communication device comprises at least one processor and a memory storing program code. The at least one processor can load and execute the program code. The at least one processor, upon executing the program code, performs a method of operating a wireless communication device in a cellular network is disclosed. The cellular network includes a plurality of cells, each cell of the plurality of cells broadcasting a cell-specific high-power reference signal The method includes obtaining, from the cellular network, an indication of multiple cells of the plurality of cells. The base stations of the multiple cells respectively broadcast a cell-specific low-power reference signal. The method also includes monitoring, while operating in an idle mode, for the cell-specific low-power reference signal. The method also includes, upon succeeding to receive the cell-specific low-power reference signal from at least one base station of at least one of the multiple cells, performing a cell re-selection from amongst the multiple cells based on the cell-specific low-power reference signal. The method further includes, upon failing to receive the cell-specific low-power reference signal, monitoring for the cell-specific high-power reference signal for performing the cell re-selection.

A method of operating a base station associated with a cell of a plurality of cells of a cellular network, each cell of the plurality of cells broadcasting a cell-specific high-power reference signal, includes providing, to a wireless communication device, an indication of multiple cells of the plurality of cells. The base stations of the multiple cells respectively broadcast a cell-specific low-power reference signal that enables cell re-selection amongst the multiple cells at the wireless communication device. The method also includes broadcasting the low-power reference signal.

A computer program or a computer-program product or a computer-readable storage medium includes program code. The program code can be loaded and executed by at least one processor. The at least one processor, upon executing the program code, performs a method of operating a base station associated with a cell of a plurality of cells of a cellular network, each cell of the plurality of cells broadcasting a cell-specific high-power reference signal. The method includes providing, to a wireless communication device, an indication of multiple cells of the plurality of cells. The base stations of the multiple cells respectively broadcast a cell-specific low-power reference signal that enables cell re-selection amongst the multiple cells at the wireless communication device. The method also includes broadcasting the low-power reference signal.

A respective base station including the at least one processor and a memory storing the program code is disclosed.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system according to various examples.

FIG. 2 schematically illustrates multiple cells of a cellular network according to various examples.

FIG. 3 is a schematic illustration of a base station according to various examples.

FIG. 4 is a schematic illustration of a UE according to various examples.

FIG. 5A is a flowchart of a method according to various examples.

FIG. 5B is a flowchart of a method according to various examples.

FIG. 5C is a flowchart of a method according to various examples.

FIG. 6 schematically illustrates signal levels obtained from channel measurements on low-power reference signals for multiple cells according to various examples.

FIG. 7 is a flowchart of a method according to various examples.

FIG. 8 is a signaling diagram according to various examples.

FIG. 9 is a signaling diagram according to various examples.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of wirelessly transmitting and/or receiving (communicating) between multiple communication nodes are described. In the various examples described herein, various types of communication systems may be used. For example, a communication network may be employed. The communication network may be a wireless network. For sake of simplicity, various scenarios are described hereinafter with respect to an implementation of the communication network by a cellular network (NW). The cellular network includes multiple cells. Each cell corresponds to a respective sub-area of the overall coverage area. Other example implementations include a multi-area wireless network such as a cellular WiFi network, etc.

Hereinafter, techniques are explained with respect to a UE communicating with a base station (BS) of a cellular NW. The BS is associated with a cell of the cellular NW.

Aspects with respect to a cell re-selection are disclosed. For example, if the signal strength of the serving cell does not fulfill a certain requirement (e.g., due to mobility), the UE performs a cell re-selection. As part of the cell re-selection, channel measurements implemented based on LP-RS broadcasted by multiple base stations (BSs) of multiple cells of the cellular NW are evaluated and it is decided whether to stay on the current cell or switch cells.

As a general rule, the cell re-selection aims to ensure that the UE to be on the best cell. For instance, a cell re-selection can be executed responsive to a further cell being better than the serving cell. For this, a relative difference of the signal strength between the serving cell and the further cell can be considered. This avoids wasting unnecessary energy on channel measurements.

Energy efficiency is a key design requirement for UEs with limited energy resource, e.g., UEs using small rechargeable and/or coin cell batteries. Among use cases, sensors and actuators are deployed extensively for monitoring, measuring, charging, etc. Generally, their batteries are not rechargeable and expected to last up to or at least few years as described in Third Generation Partnership Project (3GPP) Technical Requirement (TR) 38.875. Wearables include smart watches, rings, eHealth related devices, and medical monitoring devices. With typical battery capacity, it is challenging to sustain up to 1-2 weeks.

Various techniques disclosed herein facilitate low power consumption for such ana other types of UEs.

According to various examples, a UE contains a M-Rx and a LP-Rx. As a general rule, the LP-Rx and M-Rx may be implemented within the same hardware component(s) or may be implemented by at least one different hardware component. A use of an extra LP-Rx, in addition to the M-Rx, where the LP-Rx listens for potential DL communication, can reduce the cost of idle channel listening significantly and therefore reduce the UE power consumption.

The LP-Rx may be configured to perform time-domain processing to detect certain signals, e.g., a reference signal (RS), a wake-up signal (WUS). The time-domain processing can be in the baseband. I.e., baseband waveforms can be processed in time domain. The LP-Rx may be unfit to perform Orthogonal Frequency Division Multiplex (OFDM) demodulation, i.e., of decoding symbols on multiple orthogonal subcarriers of a joint carrier. For example, the LP-Rx may be configured to perform non-coherent decoding. For non-coherent decoding, knowledge of a reference phase is not required for signal detection.

The M-Rx may be configured for OFDM demodulation. It may be configured to perform both time and frequency-domain processing.

The LP-Rx may facilitate WUS techniques. The WUS techniques enable a UE to transition the M-Rx into a low-power state, e.g., for power-saving purposes. The MRx may also have transmit capability (i.e., a transceiver), which is however not of relevance in the discussed context. In some examples, the low-power state of the M-Rx may be an inactive state. The inactive state can be characterized by a significantly reduced power consumption if compared to an active state of the M-Rx. For example, the M-Rx may be unfit to receive any data in the inactive state such that some or all components may be shut down. Wakeup of the M-Rx from the inactive state (i.e., transitioning into an active state) is then triggered by a WUS. The inactive state can be associated with various operational modes of the terminal, e.g., a disconnected mode or idle mode. Here, a data connection between the terminal and the cellular network can be released.

The WUS can be detected by the LP-Rx. The UE may monitor, using the LN-Kx, for the WUS at predetermined WUS occasions.

Specifically, the UE may operate the LP-Rx to an active state while the M-Rx is operated in an inactive state. The UE may operate the LP-Rx in the active state while operating in an idle mode. Here, a data connection between the UE and the cellular network is not maintained.

When operating in the idle mode, the UE may use discontinuous reception (DRX), e.g., for the LP-Rx and/or the M-Rx. When using a LP-Rx, the UE can transition the M-Rx into inactive state, while only using LP-Rx (e.g., in combination with DRX). For example, the UE can transition the LP-Rx to the inactive state during off durations of the DRX. From time to time, during the on durations of the DRX, the UE transitions the LP-Rx active state. This is done for various purposes. Firstly, to see whether the cellular NW tries to reach the UE, e.g., to transmit downlink (DL) data. This could be implemented using a WUS during a WUS occasion. Secondly, to perform channel measurements for evaluation for a cell re-selection. The UE—due to mobility, e.g., during the OFF duration of the DRX—may move out of coverage of a current cell into another cell. This can be detected based on channel measurements.

Hereinafter, techniques are disclosed according to which the UE, while operating in the idle mode using DRX, can activate its LP-Rx during the ON durations of the DRX cycle to monitor for the LP-RS (i.e., attempt to receive the LP-RS). Then, based on such monitoring for the LP-RS, channel measurements can be implemented. For instance, a signal strength of any received LP-RS can be judged. Then, under certain circumstances, a cell re-selection from amongst multiple cells of the cellular network can be performed based on the channel measurements. For instance, the cell re-selection can be performed if the signal strength of the currently selected cell deteriorates below a predetermined threshold. Cell-re-selection can be performed if a further cell—different than the currently selected cell—is available that has a better signal strength than the currently selected cell.

Cell re-selection is a process where the UE decides to switch, while operating in the idle mode, from camping on a first cell to camping on a second cell, i.e., monitoring for signals from the second cell instead of from the first cell. The cell re-selection is different than a handover during connected mode; because the decision to re-select cells is done by the UE autonomously, rather than instructed Dy the cellular NW Dy a handover message.

In prior-art implementations, the reference signals (RSs) available for the cell re-selection, i.e., the synchronization signal or reference signals of the neighbor cells, can only be measured using the M-Rx. There is no support for low-power cell re-selection evaluation mechanism even if the UE is equipped with an LP-Rx.

In this disclosure, a low-power mechanism to support mobility and cell re-selection for UEs with LP-Rx is described. Hence, the UE can perform channel measurements for cell re-selection purposes using LP-Rx, without the need to activate/use the M-Rx. A procedure is disclosed so that the UE can only use the LP-Rx to perform the cell re-selection and start camping on the new cell without activating the M-Rx. This reduces the overall power consumption, while maintaining accurate mobility control.

According to some examples disclosed herein, a UE may move around cells that are included in a LP-RS neighbor cell list, without requiring additional information that would only be received using the M-Rx. The UE may obtain an indication of multiple cells, i.e., those cells in the LP-RS neighbor cell list, from the cellular network.

Techniques are described how to determine the LP-RS neighbor cell list. Various design criteria can be considered when determining the LP-RS neighbor cell list. Example design criteria include one or more of the following: only cells that operate on the same frequency or frequency range would be included in LP-RS neighbor cell list; only cells that do not bar UEs from access would be included in LP-RS neighbor cell list; only cells that are included in a common tracking area would be considered in LP-RS neighbor cell list; only cells that have same or similar WUS configuration and/or use the same timing of WUS occasions would be included in the LP-RS neighbor cell list. By using such design criteria, cell re-selection without requiring additional configuration information may be facilitated, to thereby avoid the need to activate the UE M-Rx.

The LP-RS neighbor cell list may be determined by a BS or may be determined by a core network node, e.g., a mobility-control node.

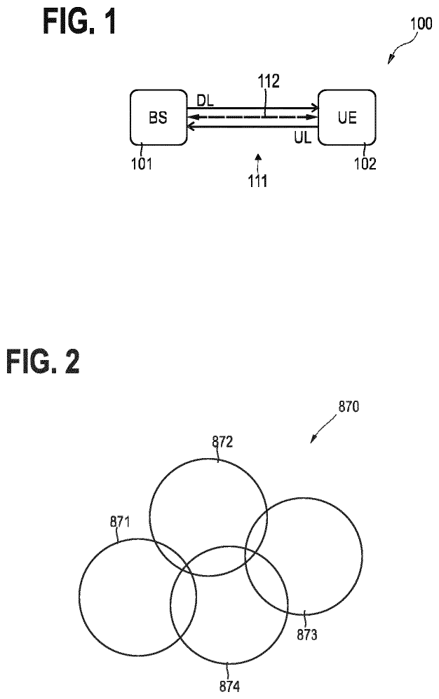

FIG. 1 schematically illustrates a communication system 100. The communication system includes two nodes 101, 102 that are configured to communicate with each other via a data carrier 111. In the example of FIG. 1, the node 101 is implemented by an access node, more specifically a BS, and the node 102 is implemented by a UE. The BS 101 can be part of a cellular NW (not shown in FIG. 1).

As illustrated in FIG. 1, there can be DL communication, as well as UL communication.

The UE 102 and the BS 101 can communicate on the data carrier 111. The data carrier 111 may include multiple subcarriers for OFDM modulation. A data link 112 can be implemented on the data carrier 111. The data link 112 can include one or more logical channels that define a time-frequency resource grid. The data link 112 can be established, e.g., based on a random-access procedure of the UE 102, e.g., responsive to paging and a wake-up event that may trigger transmission of a WUS to the UE 102. The data link 112 can be established when operating in the connected mode; but may not be established when operating in the idle mode. Idle mode is sometimes also referred to as inactive mode or, specifically in the context of 3GPP New Radio (NR), as Radio Resource Control (RRC) idle or inactive state.

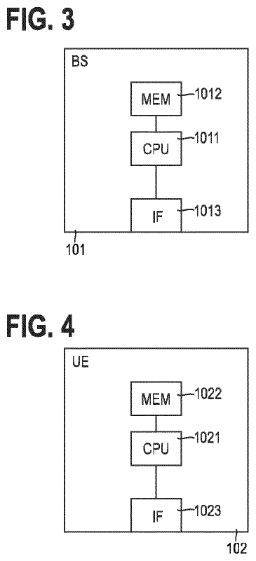

FIG. 2 schematically illustrates multiple cells of a cellular NW 870. Each cell 871-874 of the cellular NW 870 has a somewhat different coverage area. Each cell 871-874 is associated with one or more BSs such as the BS 101 according to FIG. 1. When UE mobility of a UE such as the UE 102 occurs, the UE can move from the coverage area from a given cell into the coverage area of another cell. Performing cell re-selection based on channel measurements ensures that the UE monitors for signals of the BS of the appropriate cell 871-874. Where the UE operates in the idle mode, the UE is referred to be camping on a given one of the cells 871-874 of the cellular NW 870, i.e., the serving cell.

As a general rule, the cell re-selection is based on channel measurements. One or more cell re-selection criteria can be considered. Only if the one or more cell re-selection criteria are fulfilled, the cell re-selection is executed; else, the UE does not reselect the cell. For instance, based on the channel measurement it can be judged whether the signal strength of the serving cell is at adequate level. If the signal strength of the serving cell does not fulfill one or more requirements (e.g., defined by cell re-selection information), the UE enters cell re-selection evaluation procedure where the evaluation identifies the cell that the UE should camp on. The cell reselection evaluation can include performing intra-frequency measurements on neighboring cells and/or inter-frequency measurements on neighboring cells. One example cell re-selection criterion or rule in 3GPP Technical Specification (TS) 38.304, Version 16.7.0 (2021-12), section 5.2.4.2 for Intra frequency cell re-selection purpose is: if the serving cell fulfils Srxlev>SIntraSearchP and Squal>SIntraSearchQ, the UE may choose not to perform intra-frequency measurements. Otherwise, the UE shall perform intra-frequency measurements. Here, Srxlev is Cell selection RX level value (dB); SIntraSearchP is the Srxlev threshold (in dB) for intra-frequency measurements; Squal is the Cell selection quality value (dB); and SIntraSearchQ is the Squal threshold (in dB) for intra-frequency measurements. The Rx level measurement (Srxlev threshold) is connected to the Reference Signal Received Power (RSRP) measurements and the quality measurement (Squal threshold) is connected to the Reference Signal Received Quality (RSRQ) measurements.

In prior-art implementations, the signals available for cell re-selection evaluation procedure, i.e., the synchronization signal or reference signals of the neighbor cells, can only be measured by the M-Rx. Details of such prior-art cell re-selection are disclosed in 3GPP TS 38.331, Version 17.5.0 (2022-03), Section 4.2. In such prior-art implementations, for the cell re-selection evaluation, as part of the cell selection, the UE receives and decodes the master information block (MIB) and system information blocks (SIBs), SIB1 together with SIB2-5 of any candidate cell. Respective information is taken into account when re-selecting the cell. MIB defines scheduling of SIB 1 and if cell is barred. SIB1 defines the scheduling of other system information including periodicity. SIB2 contains cell re-selection information common for intra-frequency, inter-frequency and/or inter-RAT cell re-selection. SIB4 contains information relevant only for inter-frequency cell re-selection. SIB5 contains information relevant only for inter-RAT cell re-selection. This means that the UE for performing cell re-selection, even if it is equipped with an extra LP-Rx, needs to transition the M-Rx into the active state, to receive MIB, SIB1-SIB5.

The activation of the M-Rx for performing the cell re-selection requires significant energy.

To mitigate this, techniques will be disclosed which enable performing the cell re-selection based on LP-RS, without a need of activating the M-Rx. Idle-mode mobility can be handled based on the LP-RS using LP-Rx. Thus, the M-Rx may only be required to be transitioned into the active state in the following scenarios: firstly, it there is DL payload data scheduled for transmission, e.g., as indicated by a WUS. Secondly, if there is UL payload data scheduled for transmission. In both scenarios, the UE may perform fine synchronization, in which synchronization using M-Rx is required.

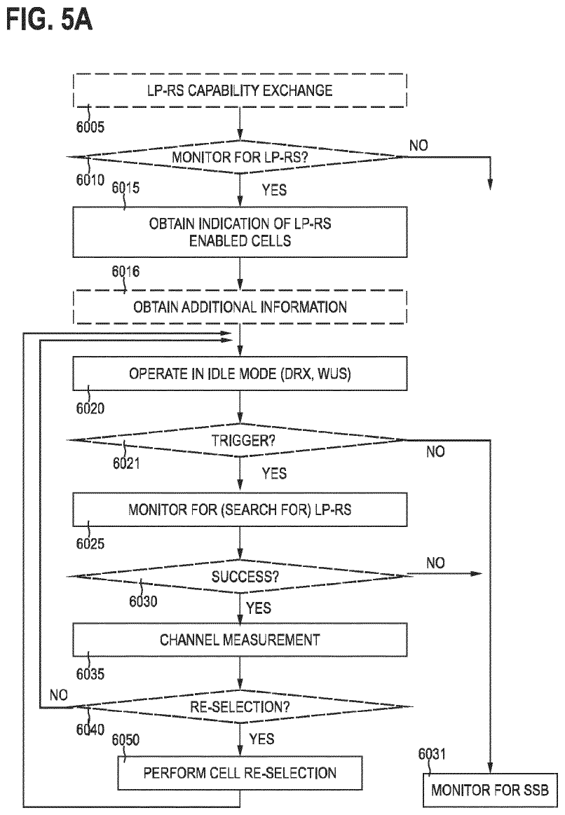

FIG. 3 schematically illustrates the BS 101. The BS 101 includes a processor 1011 and furthermore includes a memory 1012 and a communication interface 1013. The processor 1011 can communicate with the UEs 102 via the communication interface 1013. The communication interface 1013 can include analog electronics to access the carrier 111. The processor 1011 can load program code from the memory 1012 and can execute the program code. Upon executing the program code, the processor 1011 can perform techniques as described herein, e.g.: activating an SSB broadcasting pattern; activating a LP-RS broadcasting pattern; transmitting the configuration, such as the properties, of the SSB; transmitting an SSB in accordance with the SSB broadcasting pattern; transmitting the configuration, such as the properties, of the LP-RS; transmitting a LP-RS in accordance with the LP-RS broadcasting pattern; obtaining a capability from one or more UEs indicative of whether the one or more UEs are capable to receive the LP-RS and deciding on whether to activate or not to activate the LP-RS broadcasting pattern; transmitting at least one control signal indicative of the activation of the LP-RS broadcasting pattern; providing, to one or more UEs, an indication of multiple cells of the cellular NW that respectively broadcast LPRS; and/or determining the indication of the multiple cells.

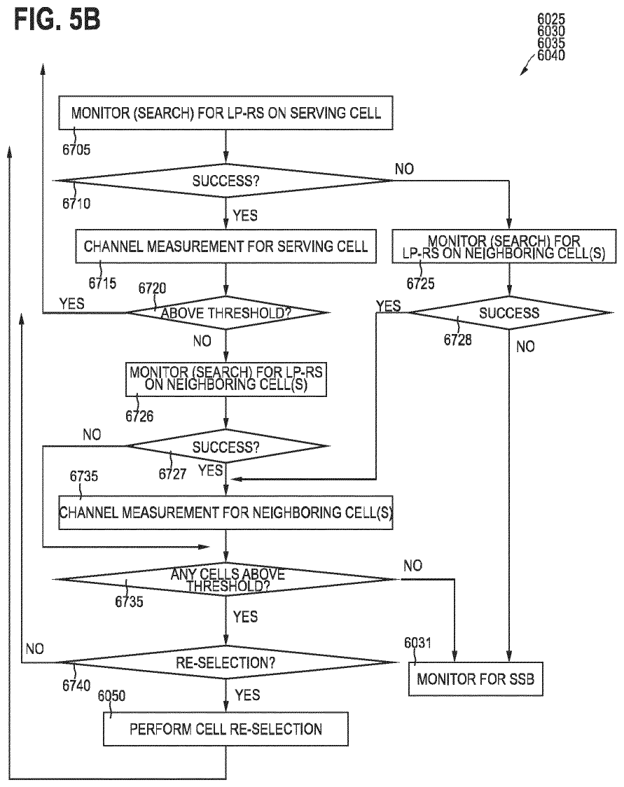

FIG. 4 schematically illustrates the UE 102. The UE 102 includes a processor 1021 and furthermore includes a memory 1022 and a communication interface 1023. The processor 1021 can communicate with the BS 101 via the communication interface 1023. The communication interface 1023 can include analog electronics to access the carrier 111. The processor 1021 can load program code from the memory 1022 and execute the program code. Upon executing the program code, the processor 1021 can perform techniques as described herein, e.g.: obtaining, from the BS 101, at least one control signal that is indicative of activation of an LP-RS broadcasting pattern; receiving the configuration, such as the properties, of the SSB and/or the LPRS; selecting between monitoring of the LP-RS and monitoring of the SSB depending on one or more decision criteria such as signal strength, mobility level, change rate of signal strength and time hysteresis of switching; obtaining, trom the cellular NW, an indication of multiple cells that support LP-RS, i.e., BSs in those cells broadcast the LP-RS; performing a cell re-selection from amongst the plurality of cells based on the LP-RS; camping on a selected cell while operating in the idle mode and in accordance with the cell re-selection; etc.

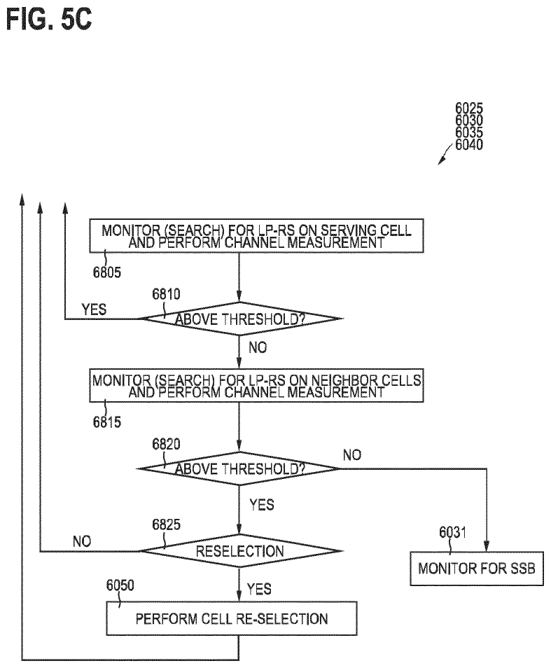

FIG. 5A is a flowchart of a method according to various examples. The method of FIG. 5A can be executed by a UE. For example, the method of FIG. 5A can be executed by the UE 102 (cf. FIG. 4). For instance, the method of FIG. 5A can be executed by the processor 1021 upon loading and executing program code from the memory 1022. The method of FIG. 5A generally pertains to performing a cell re-selection from amongst multiple cells of a cellular network based on a LP-RS.

Optional boxes are illustrated with dashed lines in FIG. 5A.

Initially, at optional box 6005, the UE can indicate its capability to the cellular NW to perform the cell re-selection based on the LP-RS. This may include the capability of the UE to monitor for the LP-RS, e.g., using the LP-Rx. The UE may indicate whether it possesses an LP-Rx.

Alternatively or additionally, at box 6005, the cellular NW may indicate, to the UE, that a broadcasting pattern for the LP-RS (LP-RS broadcasting pattern) is activated.

In general, it would be possible that any cell of the cellular NW conditionally activates the LP-RS broadcasting pattern. For instance, even when the LP-RS broadcasting pattern is activated, at the same time, an always-on broadcasting pattern of legacy reference signals can be activated. Thus, any UE, in principle, may have the choice between monitoring for legacy reference signals, e.g., using the M-Rx, or monitoring for the LP-RS, e.g., using the LP-Rx.

Such always-on legacy reference signal may pertain to the synchronization signal (SS) block (SSB). The SSB includes a primary SS (PSS) and a secondary SS (SSS). The SSB is described in 3GPP TS 38.211 v17.0.0. Thus, the always-on broadcasting pattern may be termed SSB broadcasting pattern. Since the M-Rx is required, the SSB or the PSS or the SSS may be labeled high-power RS, to delimit against the LPRS.

The LP-RS broadcasting pattern can specify a timing schedule of transmission of the LP-RS. Alternatively or additionally, the LP-RS broadcasting pattern can specify a frequency or frequency range, e.g., a bandwidth part, within which the LP-RS is transmitted. The broadcasting pattern can specify time-frequency resources of an OFDM resource grid allocated to the transmission of the LP-RS.

In detail, a UE can receive, from the BS, the control signal that is indicative of the activation of the LP-RS broadcasting pattern. Then, upon camping on the cell of the BS in an idle mode using DRX, the UE may select between monitoring of the SSB broadcasted using the SSB broadcasting pattern and monitoring of the LP-RS that is broadcasted using the LP-RS broadcasting pattern.

Next, some general aspects with respect to the LP-RS will be disclosed below.

As a general rule, the LP-RS can be designed to have the same characteristics as a WUS, i.e., can have a lower complexity than the existing reference and synchronization signals. See, e.g., 3GPP TS 36.211 Version 17.0.0, e.g., section 6.11B or section 10.2.6B.

A typical LP-RS has a simple modulation and coding technique. It can be a pseudonoise (PN) code sequence modulated by On-Off keying modulation and for instance Manchester coding or spreading and can be decoded by a simple receiver consisting of an envelope detector and a correlator. Both, LP-RS and WUS may be designed with the above design characteristics.

The configuration of WUS may be provided separate from the configuration of the LP-RS.

A WUS occasion is generally UE specific; the LP-RS is cell specific.

For instance, the LP-RS can include two synchronization signals directly adjacent to each other in time domain, i.e., mimicking the SSB structure including PSS and SSS

The LP-RS may be allocated within the same bandwidth part (BWP) as the WUS. The BWP for transmission of the LP-RS and WUS can be a part of initial BWP or can be a BWP dedicated for LP-RS and WUS transmission. Thus, for example responsive to a wake-up event associated with a given UE, the BS may transmit to that UE a WUS that is also designed for the non-coherent decoding, wherein the WUS ana the LP-RS are transmitted in a joint BWP.

The LP-RS may be transmitted on a different BWP as the SSB; this could be captured by the respective predetermined relationship between the LP-RS broadcasting pattern and the SSB broadcasting pattern. LP-RS may be transmitted in a BWP with a specific numerology and it may be different numerology than the BWP for SSB. It would also be possible that the SSB and the LP-RSs are transmitted at the same frequency, e.g., in the same BWP, or in the same center frequency.

A BWP is generally defined by a frequency range that is a subset of the entire bandwidth of a carrier. A BWP can be implemented by a contiguous set of time-frequency resources that are selected from a contiguous subset of the common time-frequency resources for a given numerology on a given carrier. BWPs are described in 3GPP Technical Specification (TS) 38.211, Version 16.4.0, 2021-01-08. I.e., different BWPs share the same carrier. In reference implementations, only a single BWP can be active at a time (active BWP) for a UE. Various techniques are available for switching between BWPs. A specific BWP can be activated by BWP indicator in DCI Format 0_1 (a UL Grant) and DCI Format 0_1 (a DL Schedule). An inactivity timer can be used. RRC signaling can be used.

The LP-RS periodicity is configurable and can be configured to have the same periodicity as the SSB periodicity. The LP-RS periodicity could also be an integer multiple of the SSB periodicity. The LP-RS periodicity could also be a fraction of the SSB periodicity. The transmission timings of the LP-RS and the SSB may be offset with respect to each other, by a certain time distance t_{d}. The time distance t_{d} may be dimensioned long enough to be able to accommodate WUS and a transition time for a main radio to wake-up. With this configuration both latency for waking up a device and UE power consumption are reduced.

The BS transmits the LP-RS in certain allocated frequency and time resources so that the LP-RS is detectable by a LP-Rx without creating any interference with other OFDM transmissions. For this, the transmitter can apply techniques as disclosed in WO 2020/074454 A1 to embed the LP-RS into an OFDM transmission to ensure both orthogonality to other OFDM transmission and reception by a non-coherent LP-Rx. LP-RS can be accommodated to more than one OFDM symbol if necessary.

For simplicity and to avoid extra configuration and design effort, the LP-RS can carry the same information bits as carried by PSS and SSS in an SSB. The LP-RS can be cell specific, i.e., encode a cell identity. Thus, the signal shape may differ from cell to cell. Thus, if a UE receives an instance of the LP-RS from a BS of a first cell and another instance of the LP-RS from another BS of a second cell, then the UE may be able to associate the received instances of the LP-RS to each one of the first cell and the second cell, respectively.

At box 6010, the UE can then decide on whether to monitor for the LP-RS or rather monitor for the SSB. This can be based on the capability exchange of box 6005. Alternatively or additionally, also power management considerations of the UE can be taken into account.

If the UE decides to opt for monitoring for the SSB, then legacy techniques can be employed (including monitoring for SSB and receiving MIB, SIBs using M-Rx).

Otherwise, the method commences at box 6015.

At box 6015, the UE obtains an indication of multiple cells of the cellular NW, wherein BSs of the multiple cells respectively broadcast the LP-RS.

The indication of the multiple cells can provide information that certain cells support and have activated the LP-RS broadcasting. The indication of the multiple cells can be a list of neighboring cells. Generally, such indication can enable the UE to find cells to camp on without being required to switch-on the M-Rx. The indication of the multiple cells can have the format of a list, a table, a rule or any other suitable format. For sake of simplicity, the indication will be referred to as LP-RS neighbor cell list hereinafter; but other formats would be possible.

The LP-RS neighbor cell list can include cell identities of each respective cell.

The LP-RS neighbor cell list can include information of a group of neighbor cells with the following one or more criteria: No cell in the LP-RS neighbor cell list bars a UE with LP-Rx; all cells in the LP-RS neighbor cell list support signaling for LP-Rx operation; and/or all cells in the LP-RS neighbor cell list are within the same geographical area.

For instance, the LP-RS neighbor cell list can define a fraction or a subset of a paging area (PA) used for paging and/or WUS transmission; the LP-RS neighbor cell list could also equate to a PA, i.e., include all cells of a PA. A PA is sometimes referred to as registration area or tracking area. The UE can be configured with information regarding time-frequency resources for monitoring for WUS and/or paging signals within the PA. The cellular NW may be configured to search for the UE, operating in the idle mode, within the PA. For instance, the UE may be configured with information regarding time-frequency resources of wake-up signal occasions for each cell within the PA. Alternatively or additionally, the UE may be configured regarding paging occasions for each cell within the PA. Once the UE leaves a PA, it may trigger a PA update.

The UE can be informed about the LP-RS neighbor cell list in different manners, depending on the implementation scenario. For instance, the LP-RS neighbor cell list can be included in system information either as a part of existing SIB that also includes other information or as part of a dedicated SIB. In such a scenario, the UE can obtain the LP-RS neighbor cell list even while operating in the idle mode, by monitoring for the respective SIB broadcast. A data connection is not required. Alternatively or additionally, it would be possible that the LP-RS neighbor cell list is included in a connection release message that triggers or implements the transition from connected mode to idle mode by releasing the data link 112 (cf. FIG. 1), e.g., a RRC release message.

At box 6016, additional information may be optionally obtained along with the LP-RS neighbor cell list.

For instance, a cell-specific transmission configuration of the LP-RS in the cells included in the LP-RS may be obtained. This may include such as sequence information/cell ID, its periodicity, time and frequency location of the LP-RS, or generally one or more parameters of the LP-RS broadcasting pattern.

Alternatively or additionally, a cell-specific transmission configuration of the WUS in the cells included in the LP-RS may be obtained. This may include such as sequence information/cell ID, its periodicity, time and frequency location of the WUS, or generally one or more parameters of the WUS occasions. This enables the UE to monitor for the WUS when camping in the cells included in the LP-RS neighbor cell list, without having to activate the M-Rx to obtain such cell-specific transmission configuration of the WUS.

Alternatively or additionally, cell re-selection information may be obtained. This cell re-selection information can correspond to the cell re-selection information in SIB2-SIB5. For instance, variable thresholds for triggering a cell re-selection may be signaled for each cell.

For instance, it would be possible that the cell re-selection information includes all or some SIB3 information according to 3GPP TS 38.331 Version 16.7.0 (2021-12) “SIB3 information element”. Intra-frequency channel measurements can be defined. This can be helpful where the cells in the LP-RS neighbor cell list all operate in the same frequency band. A minimum required received Reference Signal Received Quality (RSRQ) could be indicated. A minimum required Reference Signal Received Power (RSRP) level could be indicated. For example, a cell offset can be defined, e.g., with respect to receive signal level. A quality level offset can be defined. Such information may be helpful to calibrate the channel measurement on the respective cell, e.g., determine whether a measured signal level indicates low or high path loss, strong fading, etc.

It would be possible that a given cell re-selection information is valid for all cells in a LP-RS neighbor cell list. In another scenario, it would be possible that different cell re-selection information is provided for at least two cells in the LP-RS neighbor cell list. It would be possible to provide a respective bitmap data structure, where different entries indicate different cell re-selection information for different cells. Where two or more cells share the same cell re-selection information, this can be represented accordingly in a compact fashion, e.g., by indicating the cell re-selection information once in association with a listing of all applicable cell identities. In other words, and generally speaking, it would be possible that the cell re-selection information comprises at least one information element that is valid for (i.e., associated with) two or more of the multiple cells in the LP-RS neighbor cell list. For instance, a certain reselection threshold could be application to two or more cells or even all cells in the LP-RS neighbor cell list; then, the respective information element indicative of the reselection threshold is only signaled once.

As a general rule, it would be possible that information of box 6015 and information of box 6016 are included in a single message, e.g., a single SIB or a single connection release message. It would also be possible that respective information is included in multiple distinct messages.

To limit the signaling overhead, it would be possible that common parameter values for cells in the LP-RS neighbor cell list are only signaled once. For instance, where the same time and/or frequency resource is allocated to the LP-RS or WUS in multiple cells, such time and/or frequency resource may be indicated once and associated with the respective cells. Specific parameter values that differ from cell to cell in the LP-RS neighbor cell list may be signaled multiple times, i.e., respective values may be provided, e.g., in a bitmap structure for each cell of the LP-RS neighbor cell list.

The UE eventually operates in the idle mode at box 6020. Block 6020 may be executed before block 6015, e.g., where the information at box 6016 and/or 6016 is included in a SIB that can be obtained while the UE operates in the idle mode.

Operating in the idle mode can include switching the M-Rx to the inactive state. A data link/data connection is not maintained. While the M-Rx is in the inactive state, DRX may be implemented using the LP-Rx. This can include periodically transitioning the LP-Rx between an inactive state and an active state, in accordance with ON durations and OFF durations of a DRX cycle. During the ON durations of the DRX cycles, the UE may monitor for WUS. This could be based on additional information obtained at box 6016. The WUS could be an indication of DL data being scheduled for transmission of the cellular NW. Upon receiving the WUS, the UE can transition the M-Rx into the active state. For instance, the M-Rx may then monitor for a paging signal, e.g., a paging indicator and the subsequent paging message. Alternatively or additionally, the UE may also perform an random-access procedure to set up a data connection to the transition to the connected mode.

Then, the UE—while operating in the idle mode, box 6020—can monitor for the LPRS transmitted by BSs of cells in the LP-RS neighbor cell list, box 6025. This facilitates cell re-selection.

Sometimes, the LP-RS monitoring or LP-RS-based cell re-selection can be conditionally activated. This is illustrated in connection with optional box 6021. At box 6021, one or more trigger criteria may be checked, e.g., a power efficiency requirement of the UE and/or a mobility level of the UE and/or a service requirement of payload data scheduled for transmission from the UE or to the UE.

If the one or more trigger criteria are fulfilled, the method commences at box 6025 where the UE monitors for the LP-RS; else at box 6031, e.g., using a legacy cell reselection procedure. Thereby, conditional monitoring for LP-RS is possible.

Details with respect to monitoring for LP-RS are described next.

At box 6025, the UE attempts to receive the LP-RS (monitors for the LP-RS). The UE searches for the LP-RS. The UE uses the LP-Rx for this purpose. The M-Rx can continuously be in the inactive state during box 6025. For instance, it would be possible that the UE primarily monitors for the LP-RS of the current cell that it is camping on, i.e., on the serving cell. Only if the LP-RS of the current cell cannot be received, the UE may perform attempts to receive the LP-RS on one or more other cells included in the LP-RS neighbor cell list. For instance, such monitoring may be based on the additional information such as time and/or frequency resource and/or timing parameters of the LP-RS broadcasting pattern obtained at box 6016.

The monitoring can be based on time-domain processing of a baseband waveform that is received.

The receiving of an LP-RS may include time-domain processing to detect the waveform in the baseband. The receiving of an LP-RS may or may not include determining a signal level of a received signal. If the signal level is below a threshold, any received signals may be rejected, as not being meaningful (e.g., pertaining to interference or noise).

At box 6030, it is determined whether reception of the LP-RS was successful.

Determining whether LP-RS reception was successful can mean that it can be decided whether any LP-RS was found. Optionally, it could be judged if an LP-RS having a signal level above a certain predetermined threshold was received. Determining whether the LP-RS reception was successful can be based on one or more such and other criteria. A check hardware and/or software level of the LP-Rx can be made to determine whether the LP-RS reception was successful. In some embodiments, the determination that the reception of the LP-RS was successful is based on a criterion or rule. In some embodiments, the criterion or rule is up to implementation. The rule or criterion is based on various aspects such as power efficiency, risk of dropping connection, etc. In some embodiments determining whether the reception of the LPRS was successful comprises the received LP-RS meeting predefined criteria. In some embodiments, the rule or criterion is at least partly up to UE implementation.

If the UE failed to receive the LP-RS (or, at least, any valid LP-RS from a cell in the LP-RS neighbor cell list), a legacy procedure may be activated and followed, at box 6031. Here, the M-Rx may be transitioned to the active state and then the UE may monitor for the SSB using the M-Rx. Upon receiving the SSB, the UE may monitor for the MIB and SIB using the M-Rx. The UE can then re-select the appropriate cell based on SSB, MIB, SIB received using M-Rx.

On the other hand, if, at box 6030, it is determined that reception of the LP-RS was successful, the method commences at box 6035. At box 6035, channel measurements are implemented based on the received LP-RS. For instance, a received signal strength of the LP-RS may be determined. This may re-use the signal level that may be determined at box 6025. RSRQ and/or RSRP can be determined. The channel measurements may discriminate between the LP-RS received from different cells of the multiple cells included in the LP-RS neighbor cell list. Again, it would be possible to initially determine the channel for the serving cell; and only if degradation of the channel of the serving cell is observed proceed with determining the channel for one or more other cells of the multiple cells included in the LP-RS neighbor cell list. A cell re-selection evaluation can be made.

Note that while box 6035 and box 6025 are shown as separate boxes, as a general rule the channel measurement can be implemented together with box 6025.

Then, at box 6040, it can be determined, based on the channel measurement of box 6035, whether a cell re-selection is to be performed from amongst the multiple cells. This can be based on the cell re-selection evaluation. As part of the cell re-selection evaluation, one or more cell re-selection criteria can be checked (details will be described in connection with FIG. 5B). In other words, the can UE determine whether it may relocate to one of the multiple cells where LP-RS is transmitted. If this is possible, it is typically feasible for power saving reasons.

As a general rule, various options are available for the cell re-selection evaluation. One option is described next; a specific option will also be disclosed in connection with FIG. 5B below. For instance, the check at box 6040 can include determining the received signal strength of the LP-RS at box 6035 and comparing the received signal strength of the LP-RS of the serving cell with the predetermined threshold at box 6040. This corresponds to checking a cell re-selection criterion. The predetermined threshold could be defined in absolute terms and/or with respect to a neighbor cell signal level. If the determined received signal strength of the LP-RS of the serving cell is above the predetermined threshold, then a re-selection may not be performed; if, on the other hand, the determined received signal strength of the LP-RS of the serving cell is below the predetermined threshold, e.g., for certain time duration, then the cell re-selection may be performed. It would be possible that the received signal strength of one or more other cells included in the LP-RS neighbor cell list are evaluated and the strongest cell is then selected for camping on at box 6040. This corresponds to a cell re-selection criterion. One or more parameters specified by cell reselection information may be considered, e.g., as obtained as part of box 6016. Generally, the cell re-selection information can parameterize or specify one or more cell re-selection criteria.

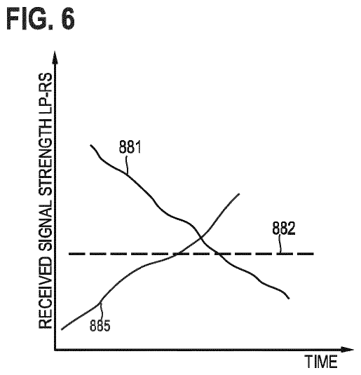

As a general rule, the decision making at box 6040 can vary according to the scenario. An example detailed implementation of the decision-making is disclosed next. For example, when signal strength (γ) of the LP-RS in the serving cell is sufficient, i.e., above a certain level γ>l₁ (specified by cell re-selection information of that cell), the UE continues camping on the cell. This could be determined based on a secondary synchronization signal included in the LP-RS (without considering a primary synchronization signal included in the LP-RS). If the signal strength of the LP-RS of the serving cell does not fulfill the measurement criterion, i.e., l₂<γ<l₁, the UE monitors for LP-RS of the neighbor cells. Here, the UE can receive and evaluate, both, primary synchronization signal and secondary synchronization signal included in the LP-RS, if available. As soon as the signal strength of the serving cell becomes weak, i.e., goes below a certain level, γ<l₂, the UE cannot camp on that cell. The UE then needs to perform a cell search on LP-RS of the cells in the LP-RS neighbor cell list to find a suitable cell to camp on. If the UE moves outside the coverage area defined by the cells included in the LP-RS neighbor cell list in which it is indicated that all measurements based on LP-RS is below the threshold (12) then the UE fails to receive any such LP-RS from cells in the LP-RS neighbor cell list, cf. box 6030, ana the UL activates the M-Rx to perform cell re-selection using the legacy approach. For instance, FIG. 6 illustrates the signal strength 881 measured on the LP-RS of the serving cell over time; and the respective threshold 882. Also illustrated is the signal strength 885 of the LP-RS broadcasted by a neighboring cell over time that tends to increase.

Referring again to FIG. 5A: If the cell re-selection is not performed, the method commences with box 6020, i.e., the UE continues to operate in the idle mode and continues to camp on the serving cell. Otherwise, the method commences at box 6050; at box 6050, the cell re-selection is performed. The UE may then camp on the re-selected cell without requiring MIB or SIB. More specifically, based on, e.g., additional information obtained at box 6016, the UE can assume that it is not barred from access and fulfills the re-selection requirements in accordance with such cell re-selection information.

Summarizing, the method of FIG. 5A enables the UE to move around in the cells included in the LP-RS neighbor cell list by only evaluating LP-RS of the neighbor cells. While camping in a cell, the UE needs to monitor for WUS using LP-Rx. As long as UE can camp on one of the cells listed in the LP-RS neighbor cell list, when performing cell re-selection, the UE does not need to receive any information related to SIB1-SIB5, rendering unnecessary to power up the M-Rx into its active state. The M-Rx can be continuously operated in its inactive state until after performing the cell re-selection, e.g., until receiving a WUS. This is due to the fact that LP-RS is sufficient for cell re-selection evaluation and cell re-selection procedure. The advantage of this approach is that the UE does not have to read MIB/SIBs when moving to a new cell.

Note that in some scenarios the order of the boxes in FIG. 5A may vary. For instance, it would be possible to implement the channel measurements together with the monitoring for the LP-RS, i.e., in a single process.

FIG. 5B is a flowchart that describes a specific implementation of box 6025, 6030, 6035, and 6040 of FIG. 5A. FIG. 5B illustrates aspects with respect to a cell re-selection evaluation.

At box 6705, the UE initially selectively attempts to receive LP-RS transmitted by the BS of the serving cell. A respective filter may be used. In other words, the UE can search for the LP-RS transmitted by the BS of the serving cell. The UL may monitor specific resources. Box 6710 thus corresponds to evaluating whether the serving cell is detected and strong enough so that the UE is allowed to camp on the cell. Box 6705 thus corresponds to box 6025.

The UE, at box 6710 the UE then determines whether it was able to receive the LPRS of the serving cell. This can include determining whether a respective signal level is above a threshold. This corresponds to box 6030.

If the LP-RS associated with the serving cell is received, the UE performs a channel measurement at box 6715 based on this LP-RS of the serving cell. RSRQ and/or RSRP could be determined. This corresponds to box 6035.

Box 6715 may sometimes be implemented as part of box 6705.

A respective quantity of the channel measurement can then be compared against a certain threshold, at box 6720. This implements a tier-1 cell re-selection criterion. This is part of the cell re-selection evaluation. For instance, it could be checked if the RSRQ and/or RSRP are better than a certain fixed value/threshold. If the threshold comparison yields a positive result (i.e., serving cell sufficiently strong), a cell re-selection is not necessary; this corresponds to the NO-branch of box 6040.

At box 6725—triggered either by not being able to receive LP-RS from the serving cell, box 6710 the UE attempts to receive the LP-RS from neighboring cells, according to the LP-RS cell list. This corresponds again to box 6025. If the UE does not succeed at box 6725—a respective check is implemented at box 6728 —, a fallback to monitoring SSB is performed, corresponding to box 6031. Else, the UE performs a channel measurement for the received LP-RS at box 6735 (corresponding to box 6035).

Also, if at box 6720 it is judged that the LP-RS of the serving cell are not good enough (e.g., RSRQ and/or RSRP below a threshold), the UE attempts to receive the LP-RS from neighboring cells, according to the LP-RS cell list at box 6726. Box 6726 thus corresponds to box 6725. A check whether any LP-RS was received is implemented at box 6727 (thus corresponding to box 6728). In the affirmative, box 6735 is implemented and channel measurement(s) are performed.

At box 6735, the UE determines whether any cells for which the LP-RS was received are above a certain predetermined threshold; if not, fallback to SSB monitoring at box 6031 is executed. The threshold at the box 6735 may be different (i.e., lower) than the threshold at the box 6720.

Box 6735 may sometimes be executed together with box 6726 or box 6725, respectively.

For instance, both at box 6720 as well as at box 6735 RSRP and/or RSRQ may be compared against respective thresholds. The RSRP and/or RSRQ threshold at box 6720 can be higher than the RSRP and/or RSRQ threshold at box 6735.

If the threshold comparison at box 6735 is successful (i.e., at least one sufficiently strong cell), then, at box 6740, it is determined whether cell re-selection is to be executed at box 6050 or whether to continue camping on the serving cell.

For box 6740 different implementations are conceivable. For instance, where box 6715 was executed, the RSRP and/or RSRQ of the neighboring cells (as determined at box 6735) may be determined against a threshold that depends on RSRP and/or RSRQ of the serving cell determined from box 6715. Else, a fixed threshold may be used. Or a threshold may be used that is based on the last-measured RSRP and/or RSRQ of the serving cell. All these options explained above implement tier-2 cell reselection criteria.

FIG. 5C is a flowchart that describes a specific implementation of box 6025, 6030, 6035, and 6040 of FIG. 5A. FIG. 5C illustrates aspects with respect to a cell re-selection evaluation.

FIG. 5C generally corresponds to FIG. 5B. However, in FIG. 5C, the channel measurements are implemented together with searching for LP-RS, either from the serving cell at box 6805 (corresponding thus to boxes 6705 and 6715) or neighboring cells at box 6815 (corresponding thus to boxes 6725, 6726, 6735).

Also, the check for successful reception and whether a minimum threshold is met is combined, at box 6810 for the serving cell (corresponding to boxes 6710, 6720) and at box 6820 (corresponding to boxes 6728, 6727, 6735). The threshold at the box 6820 may be different (i.e., lower) than the threshold at the box 6810.

The re-selection evaluation at box 6825 corresponds to box 6740.

The combination of LP-RS search and channel measurement as illustrated in FIG. 5C is generally an option available for all scenarios disclosed herein.

As will be appreciated from FIG. 5A, FIG. 5B, and FIG. 5C, as a general rule, where LP-RS are received from at least one cell, it is possible to execute the cell re-selection evaluation based on the LP-RS. One or more re-selection criteria can be evaluated based on the receive LP-RS. Then the re-selection may or may not be actually executed, depending on whether the one or more cell re-selection criteria are met. The one or more cell re-selection criteria can be signaled by the network, e.g., using cell re-selection information.

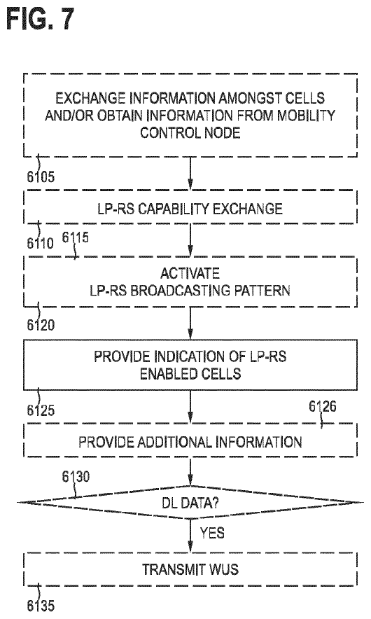

FIG. 7 is a flowchart of a method according to various examples. The method of FIG. 7 can be executed by a BS associated with a cell of a cellular NW. For example, the method of FIG. 7 can be executed by the BS 101 (cf. FIG. 3). For instance, the method of FIG. 7 can be executed by the processor 1011 upon loading and executing program code from the memory 1012. The method of FIG. 7 generally pertains to control signaling with one or more UEs to facilitate cell re-selection by the one or more UEs based on a LP-RS.

Optional boxes are shown with dashed lines in FIG. 7.

At optional box 6105, information is exchanged between the BS and one or more further BSs of the cellular NW. For instance, information can be provided to one or more BSs or can be obtained from one or more further BSs. Based on such information, it is possible to determine a LP-RS neighbor cell list. For instance, it is possible to determine which re-selection configuration parameters and/or WUS parameters and/or LP-RS broadcasting pattern parameters include similar values for the various cells. For example, it would be possible to determine which cells are to be grouped into the LP-RS neighbor cell list, e.g., based on coverage area considerations and/or based on the capability considerations. For instance, such cells can be included in the LPRS neighbor cell list that have the same cell re-selection information and/or the same WUS occasion timing and/or the same LP-RS broadcasting pattern.

Where BSs exchange information, a radio-access network (RAN) contained determination of the LP-RS neighbor list is possible. This may be helpful for RRC Inactive mode that is transparent to the core network.

Alternatively or additionally to exchanging such information between multiple cells, it would also be possible that at least a part of the information is obtained from the core network, e.g., from a mobility-control node of the core network. An example mobility control node would be the 3GPP NR Access and Mobility Function (AMF).

In some scenarios, it would be possible that the LP-RS neighbor cell list is obtained from a core network mobility control node of the cellular network.

It would also be possible that the LP-RS neighbor cell list is predetermined, e.g., fixedly configured.

At box 6110, a capability for activating the LP-RS broadcasting pattern can be exchanged between the BS and the UE. Box 6110 corresponds to box 6005 of the method of FIG. 5A.

In some scenarios, it would then be possible, at box 6115, to conditionally activate the LP-RS broadcasting pattern. Sometimes, the LP-RS broadcasting pattern may only be activated if there is a minimum count of UEs camping on the respective cell that support monitoring for the LP-RS, to give just one example.

The LP-RS broadcasting pattern is activated contemporaneously to an SSB broadcasting pattern.

While the LP-RS broadcasting pattern is activated, the BS repetitively broadcasts the LP-RS. The LP-RS enables cell re-selection at the UE, amongst cells included in an LP-RS neighbor list.

At box 6125, the BS can provide, to a UE, an indication of multiple cells that respectively broadcast the LP-RS. In other words, the LP-RS neighbor cell list can be provided to a UE. It would be possible that such information is broadcasted or transmitted in a directed message, e.g., an RRC control message. A connection release message could be used to provide the LP-RS neighbor cell list. A SIB could be used.

Box 6125 corresponds to box 6015 of the method of FIG. 5A.

At box 6126, additional information associated with the LP-RS neighbor cell list can be provided to one or more UEs. Box 6126 corresponds to box 6016 of the method of FIG. 5A.

Box 6125 and box 6126 can sometimes be implemented together, i.e., where respective information is included in a single message.

At box 6130, it can be checked whether SL data is scheduled for transmission to a UE. In the affirmative, at box 6135, a WUS can be transmitted, the WUS being associated with that UE. For instance, the WUS can be transmitted during an on duration of the DRX cycle associated with that UE. Information about the downlink data scheduled for transmission to the UE can be obtained from a mobility control node of the cellular NW.

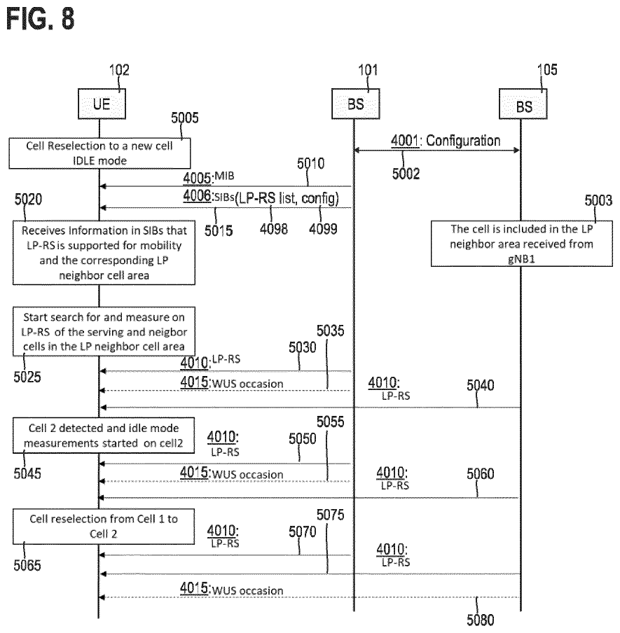

FIG. 8 is a signaling diagram of communication between the BS 101 and the UE 102, as well as a further BS 105 that is arranged in the neighborhood of the BS 101 and associated with another cell of the cellular NW.

In the scenario of FIG. 8, the UE 102 continuously operates in the idle mode.

For instance, the signaling of FIG. 8 may implement the method of FIG. 5A in the method of FIG. 7.

At 5002, configuration information is optionally exchanged between the BS 101 and the BS 105. Based on such configuration information the BS 101 and/or the BS 105 can determine a LP-RS neighbor cell list.

For instance, information on whether a respective LP-RS broadcasting pattern is activated in the cell associated with the BS 101 as well as in the cell associated with the BS 105 may be exchanged. Information on the time and/or frequency resources used for the LP-RS transmission can be exchanged. It can be determined whether WUS occasions are compatible or even the same. It can be determined whether the BS 101, 105 provide carriers in the same frequency range or at the same frequency.

Based on such and other considerations, it can be determined whether the cells associate with the BS 101 and the BS 105 are to be grouped in a common LP-RS neighbor cell list.

The signaling at 5002 is generally optional. For instance, in some scenarios the LP-RS neighbor list may be predetermined. It would also be possible that the BS 101 obtains the LP-RS neighbor list from a mobility control node of the core network. In another scenario, such configuration could also be implemented by means of an operation and maintenance interface in a deployment phase.

At 5005, the UE 102 performs a cell re-selection to the cell associated with the BS 101, while operating in the idle mode. For instance, the cell re-selection could be based on monitoring the SSB including the PSS and SSS.

Then, the UE 102, at 5010, can receive the MIB 4005 and, at 5015, receive one or more SIBs 4006, broadcasted by the BS 101.

One or more of the SIBs be indicative of the LP-RS neighbor cell list 4098 and, optionally, additional information 4099, as previously explained in connection with box 6015 and box 6016, respectively (cf. FIG. 5A); and box 6125 and 6126, respectively (cf. FIG. 7). The additional information 4099 can pertain to WUS configurations for each cell in the LP-RS neighbor cell list 4098 and/or cell re-selection information configurations for each cell in the LP-RS neighbor cell list 4098.

At box 5020, the UE 102 then determines that the LP-RS broadcasting pattern is activated and that cell re-selection based on the LP-RS monitoring is supported. This is based on the information obtained at 5015.

Accordingly, at box 5025, the UE monitors for the LP-RS broadcasted by the BS 101 and the BS 105, because the respective cell identities are both listed in the LP-RS neighbor cell list 4098. It can be said that the UE searches for the LP-RS.

The UE 102 receives, at 5030, the LP-RS 4010 broadcasted by the BS 101 and receives, at 5040, the LP-RS 4010 broadcasted by the BS 105 (cf. FIG. 5A: box 6025). The UE 102 can perform channel measurements based on the LP-RS 4010 broadcasted by the BS 101, as well as the LP-RS 4010 broadcasted by the BS 105, respectively.

At 5035 the UE 102 also monitors for a WUS 4015 at a respective WUS occasion. In the illustrated scenario, the BS 101 does not transmit the WUS 4015 (e.g., there is no DL data scheduled for transmission to the UE 102).

At 5045, the UE 102 determines that it continues to camp on the cell associated with the BS 101. A cell re-selection to the cell associated with the BS 105 is not performed (cf. FIG. 5A: box 6040). For instance, a signal strength of the LP-RS 4010 that is transmitted by the BS 101 may be above a certain threshold and/or may be larger than the signal strength of the LP a-RS 4010 that is broadcasted by the BS 105. Respective aspects have been disclosed above in connection with FIG. 6.

After a certain time duration, e.g., at the next ON duration of the DRX cycle, the UE 102 can, again, monitor for the LP-RS 4010 broadcasted by the BS 101, as well as the BS 105, at 5050 and 5060. The UE can also monitor again for the WUS 4015, at 5055.

The UE monitors for the LP-RS 4010 when the LP-Rx is in the active state.

At 5065, a cell re-selection is performed, from the cell associated with the BS 101 to the cell associated with the BS 105. The decision can be made at the UE 102 based on the signal levels of the LP-RS 4010 broadcasted by the BS 101 of the LP-RS broadcasted by the BS 105, respectively. The details with respect to the cell re-selection have been disclosed above in connection with box 6040 of the method of FIG. 5A. The M-Rx is not required for any one of 5030, 5035, 5040, 5050, 5055, and 5060.

Upon performing the cell re-selection, the UE 102 continues to operate in the idle mode. At 5070 and 5075 the UE 102 then monitors for the LP-RS, e.g., broadcasted by the BS 101 and the newly-serving BS 105, respectively (and possibly further neighboring cells). The UE monitors for the WUS 4015 of the new serving cell associated with the BS 105, at 5080. The UE may use respective WUS configuration included in the information 4099.

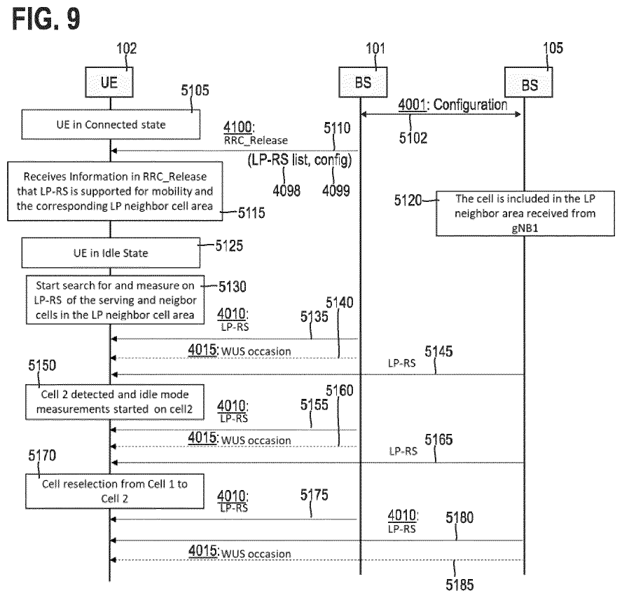

FIG. 9 is a signaling diagram of communication between the BS 101 and the UE 102, as well as a further BS 105 that is arranged in the neighborhood of the BS 101 and associated with another cell of the cellular NW.

In the scenario of FIG. 9, the UE initially operates in the connected mode (different than in the scenario of FIG. 8).

For instance, the signaling of FIG. 9 may implement a method of FIG. 5A and the method of FIG. 7.

The signaling of FIG. 9 generally corresponds to the signaling of FIG. 8. It, however, differs in that the LP-RS neighbor cell list and, optionally, associated information 4099 is included in the RRC release message transmitted by the BS 101 to the UE 102, thereby triggering the transition of the UE 102 from operating in the connected mode at box 5105 to operating in the idle mode at box 5125.

Other than this, 5120 corresponds to 5002; 5115 corresponds to 5020; 5130 corresponds to 5025; 5135 corresponds to 5030; 5140 corresponds to 5035; 5445 corresponds to 5040; 5150 corresponds to 5045; 5155 corresponds to 5050; 5160 corresponds to 5055; 5165 corresponds to 5060; 5170 corresponds to 5065; 5175 corresponds to 5070; 54180 corresponds to a 5075; 5185 corresponds to 5080.

Summarizing, a low-power mechanism to support cell re-selection and mobility for UEs with LP-RX has been disclosed.

The UE can be configured to perform cell-reselection monitoring using LP-RX, when being released to Idle mode via RRC signaling. Alternatively, the information is provided in SIB.

Such neighbor cell information includes information for the UE to be able to measure and reselect to a neighbor cell using LP-Rx, monitoring/measuring LP-RS, in serving and when needed in neighbor cells.

The UE does not have to use the M-Rx to do the cell re-selection.

Also, information whether the cell is suitable and not barred can be detected either via the LP-RS in the cell, or via system information in last serving cell, indicating barring status of the set of neighbor cells that are indicated to be available to LP cell reselection.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a wireless communication device in a cellular network comprising a plurality of cells, each cell of the plurality of cells broadcasting a cell-specific high-power reference signal, the method comprising:
obtaining, from the cellular network, an indication of multiple cells of the plurality of cells, wherein base stations of the multiple cells respectively broadcast a cell-specific low-power reference signal,
monitoring, while operating in an idle mode, for the cell-specific low-power reference signal,
upon succeeding to receive the cell-specific low-power reference signal from at least one base station of at least one of the multiple cells, performing a cell re-selection from amongst the multiple cells based on the cell-specific low-power reference signal, and
upon failing to receive the cell-specific low-power reference signal, monitoring for the cell-specific high-power reference signal for performing the cell reselection.

2. The method of claim 1, further comprising:
obtaining, from the cellular network, a cell-specific transmission configuration of the cell-specific low-power reference signal for the multiple cells,
wherein said monitoring for the cell-specific low-power reference signal is in accordance with the cell-specific transmission configuration.

3. The method of claim 1, further comprising:
obtaining, from the cellular network, a cell-specific transmission configuration of a wake-up signal for the multiple cells, and
monitoring, while operating in the idle mode, for the wake-up signal in accordance with the cell-specific transmission configuration.

4. The method of claim 1, further comprising:
obtaining, from the cellular network, cell re-selection information for the multiple cells and associated with the cell-specific low-power reference signal,
wherein the cell re-selection is performed in accordance with the cell re-selection information.

5. The method of claim 4,
wherein the cell re-selection information comprises at least one information element valid for two or more of the multiple cells.

6. The method of claim 4,
wherein the cell re-selection information specifies one or more cell re-selection criteria evaluated at the wireless communication device prior to performing the cell reselection.

7. The method of claim 1,
wherein the indication of the multiple cells is broadcasted in a system information block by the base station of a respective cell of the multiple cells.

8. The method of claim 1,
wherein the indication of the multiple cells is included in a connection release message triggering the operation in the idle mode.

9. The method of claim 1, further comprising:
controlling a low-power receiver of the wireless communication device to execute said monitoring for the cell-specific low-power signal, and
controlling a main receiver of the wireless communication device to execute said monitoring for the cell-specific high-power reference signal.

10. The method of claim 9, further comprising:
while monitoring for the cell-specific low-power reference signal and until after performing the cell re-selection, continuously operating the main receiver in an inactive state.

11. The method of claim 1,
wherein said monitoring for the cell-specific low-power reference signal comprises performing time-domain processing of baseband waveforms.

12. The method of claim 1,
wherein the cell re-selection is selectively performed based on the cell-specific reference signal if one or more trigger criteria are fulfilled,
wherein if the one or more trigger criteria are not fulfilled, said monitoring for the cell-specific high-power reference signal is executed for performing the cell re-selection.

13. The method of claim 12,
wherein the one or more trigger criteria comprise at least one of a power efficiency requirement, a mobility of level of the wireless communication device, or a service requirement of a service associated with payload data scheduled for transmission.

14. The method of claim 1, further comprising:
upon succeeding to receive the cell-specific low-power reference signal from at least one base station of at least one of the multiple cells, evaluating whether one or more cell re-selection criteria are fulfilled based on the cell-specific low-power reference signal,
wherein the cell re-selection is selectively performed if the one or more cell reselection criteria are fulfilled.

15. The method of claim 1, further comprising:
upon succeeding to receive the cell-specific low-power reference signal from the at least one base station of the at least one of the multiple cells and if a signal level or a signal quality of the cell-specific low-power reference signal is below a predetermined threshold, monitoring for the cell-specific high-power reference signal for performing the cell re-selection.

16. A method of operating a base station associated with a cell of a plurality of cells of a cellular network, each cell of the plurality of cells broadcasting a cell-specific high-power reference signal, the method comprising:
providing, to a wireless communication device, an indication of multiple cells of the plurality of cells, base stations of the multiple cells respectively broadcasting a cell-specific low-power reference signal that enables cell re-selection amongst the multiple cells at the wireless communication device, and
broadcasting the low-power reference signal.

17. The method of claim 16, further comprising:
determining the indication of the multiple cells based on information exchanged between the base station and one or more further base stations of the cellular network.

18. The method of claim 17, further comprising:
obtaining the indication of the multiple cells from a mobility control node of a core of the cellular network.

19. The method of claim 16,
wherein the multiple cells from a fraction of a tracking area associated with the wireless communication device.
